(19) United States
(12) Patent Application Publication
(10) Pub. No.: US 2011/0108061 A1
(43) Pub. Date: May 12, 2011

(54) Cleaning Article

(76) Inventors: John Squeri, Downingtown, PA (US); Franz Shelley, Oxford, PA (US)

(21) Appl. No.: 12/617,061

(22) Filed: Nov. 12, 2009

(51) Int. Cl. B08B 7/00; A47L 13/16

(52) U.S. Cl. 134/6; 15/209.1

(57) ABSTRACT

A cleaning pad having a porous structure and enhanced thermal resistance is provided. The cleaning pad is made from a fluoropolymer material and includes a cleaning agent and an evaporative agent.

### FIELD OF THE INVENTION

This invention relates to cleaning articles for food cooking surfaces, such as cleaning sheets and pads incorporating porous PTFE and a cleaning agent.

### BACKGROUND

The surfaces of commercial grills, griddles, toasters, planchas and other flat cooking surfaces used in the restaurant, catering, and institutional food preparation industries are subjected to high heat and are eventually soiled by baked-on food deposits such as fats, oils, and other organic food products.

The removal of these soils is critical to ensure consistent quality of food preparation, and minimize the energy needed to cook the food. Adhered soils can create variation in heat transfer across the cooking surface, causing inconsistent cooking of food. This could potentially lead to under-cooked food which can compromise food safety, or even if fully cooked, poor end quality as perceived by the consumer.

Cleaning of the cooking surfaces is done frequently, usually on a daily basis. It requires considerable labor and the use of powerful, often caustic, chemical cleaners. Generally, the cleaners are manually measured, dispensed, and applied to the cooking surface. This is usually done while the grill is still hot (200° F.-550° F.), thus creating a safety hazard for the crew operators who must clean the grill. In addition, excessive cleaning fluid is often applied to heated grills, as the high temperatures tend to evaporate the cleaning fluid quickly, resulting in variability of cleaning fluid coverage.

Once applied, the cleaner must be distributed evenly over the cooking surface, usually by a wire brush, scouring pad, or wet cloth. This introduces variability of coverage dependent on the operator and the tool used. The cleaner is allowed to sit on the cooking surface for a period of time, then the cooking surface is scrubbed manually. Again, most of this is done while the grill is hot, desirably at a temperature of between about 100 F and about 550 F.

After scrubbing, the cleaner; loosened soils; and other effluent are removed from the cooking surface via water wash or wet cloth. This process is generally messy and results in waste that cannot readily be thrown away in the trash, resulting in added environmental concerns and added expense for disposal.

Attempts have been made to improve cleaning of cooking surfaces in a variety of commercial, home and other applications.

U.S. Pat. No. 7,056,874 to Tadrowski et al describes cleaning solutions for carbon removal. The invention is directed to cleaning solutions comprising a combination of components, which results in cleaning solutions having one or more desired properties including, but not limited to, cleaning solution stability up to a temperature of about 262.8° C. (505° F.). These cleaners may be applied to a heated or room temperature grill by pouring, spraying or applying with a scrub pad or cloth such as a heat-resistant, no-scratch pad. The cleaning solution is allowed to remain on the cooking surface for a period of time, scrubbing may be carried out, then the surface is wiped with a damp cloth to remove cleaning solution and particulate matter.

U.S. Pat. No. 6,833,033 to Knight describes a grill cleaner and method. The patent teaches the use of fluid-absorbent pieces of material (such as natural sponge, synthetic sponge, foam rubber and similar foam synthetics, or paper) formed in a wave-like shape that meshes with the wave-like contours of electric grill heating platens, in order to dramatically simplify the cleaning of an electric grill. It is described in the patent that the wave-like shape absorbent material, when wetted and placed inside of the grill (when the grill is off and completely cooled from cooking), and left in place for an hour or so, will loosen the baked-on material automatically—so that the baked-on material can be wiped off. This method is performed at cool temperatures.

Despite the teachings of these patents, a need still exists for improved articles and methods to clean cooking surfaces more effectively while minimizing costs, reducing chemical usage and environmental impact, and reducing safety hazards to the end user.

### SUMMARY OF THE INVENTION

The present invention is an easy-to-use high temperature (thermally stable up to 550° F.) grill cleaning sheet that uniformly and efficiently delivers cleaning chemicals or cleaners or cleaning products to the surface to be cleaned. Use of these improved grill cleaning sheets allows cleaning at high temperatures (e.g., up to 550° F.), and minimizes the clean-up of loosened soils would be highly valued by those using grills, toasters, planchas, fryers, ovens, etc.

The present invention addresses problems associated with cleaning hot grills that include inconsistent dispensing and distribution of cleaning chemistries over the cooking surface. The various embodiments of the present invention eliminate the need for excessive use of cleaning agents, reduce fire hazards and reduce labor. The material choices have a limiting oxygen index (LOI) greater than about 22% and a melting temperature greater than about 250° F. These materials are porous articles such as woven fabrics, porous sheets, and absorbent large pore films. The large pore materials can be imbedded with a volatile material such as cleaning agents, surfactants, solvents or combinations thereof. The creation of pouches, laminates, pads and combinations of these enables both the application of proper cleaning fluid concentration and improved contact of the cleaning article with the cooking surfaces, both of which enhance cleaning.

An aspect of the invention addresses a cleaning pad having at least one porous PTFE sheet having pores and having a density of up to about 1.5 g/cc, desirably up to about 1.0 g/cc, more desirably up to about 0.5 g/cc. The cleaning pad also has a cleaning agent and an evaporative agent wherein at least a portion of the pores contains the cleaning agent and the evaporative agent.

The cleaning agent may be water, alcohol, soap, or the like and the evaporative agent may be acetone. Desirably, the cleaning agent is adapted to facilitate the uptake of soil into said pores of the cleaning pad, and the evaporative agent facilitates the uptake of the cleaning agent into the cleaning pad. The cleaning pad is porous and has a bubble point of 0.15 MPA or less, desirably 0.10 MPA or less.

Another aspect of the invention addresses a cleaning pad having at least one porous PTFE sheet having pores and having a density of up to about 1.5 g/cc. The cleaning pad also has a cleaning agent and an evaporative agent wherein at least a portion of the pores contains the cleaning agent and the evaporative agent. The cleaning pad further has a release layer adjacent the at least one porous PTFE sheet.

Yet another aspect of the invention addresses a cleaning pad including a pillow and having at least one porous PTFE sheet having pores and having a density of up to about 1.5 g/cc. The cleaning pad also has a cleaning agent and an evaporative agent wherein at least a portion of the pores contains the cleaning agent and the evaporative agent.

Another aspect of the invention addresses a method of cleaning a soiled cooking surface. The method includes the steps of providing at least one porous PTFE sheet having pores; applying an evaporative agent to the at least one porous PTFE sheet comprising pores; applying a cleaning agent to the at least one porous PTFE sheet comprising pores; placing the at least on porous PTFE sheet comprising pores onto a soiled cooking surface; evaporating the evaporative agent; distributing the cleaning agent onto the soiled cooking surface; and drawing the soil from the cooking surface onto the PTFE sheet.

Yet another aspect of the invention addresses a method of cleaning a soiled cooking surface. The method includes the steps of providing a cleaning pad having at least one porous PTFE sheet comprising pores; a cleaning agent, and an evaporative agent; placing said cleaning pad onto a soiled cooking surface; evaporating the evaporative agent; distributing the cleaning agent onto the soiled cooking surface; and drawing the soil from the cooking surface onto the cleaning pad.

### BRIEF DESCRIPTION OF THE DRAWINGS

FIG. 1 is a cross-sectional view of an embodiment of a single layer cleaning pad

FIG. 2 is a cross-sectional view of a multilayer cleaning pad.

FIG. 3 is a cross-sectional and perspective view of a pillow shaped cleaning pad.

FIG. 4 is an SEM of the PTFE layer used in Example 1

FIG. 5 is a schematic representation of a scrim material suitable for incorporation in the pads of the invention

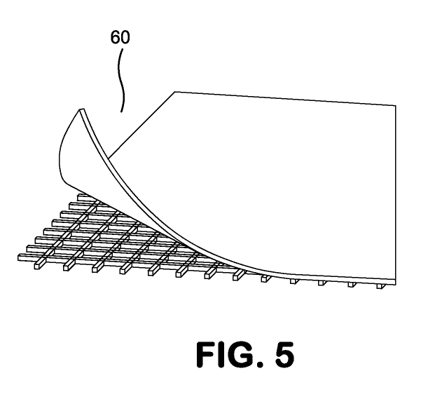

### DETAILED DESCRIPTION OF THE INVENTION

The present invention enables the cleaning of hot grills thereby eliminating costly cool down time and increasing the productive use of the grill. Alternatively, the present invention offers a safer, more cost effective means of cleaning hot grills. The cleaning pad material is thermally stable up to about 288° C. (550° F.). Furthermore, the cleaning pad possesses sufficient strength to withstand shrinkage and tearing at elevated cooking temperatures (up to about 550° F.). The cleaning pad possesses the additional attribute that it simultaneously loosens and absorbs or otherwise captures tightly adhered fat proteins and soils, a feature that minimizes the amount of scrubbing time required to clean the grill cover.

Articles of the present invention also exhibit high Limiting Oxygen Index (LOI) values. LOI is widely used for the determination of the relative flammability of polymeric materials. It indicates the minimum concentration of oxygen in a nitrogen/oxygen mixture required to support combustion of a test sample under specified test conditions in a vertical position. (The top of the test sample is inflamed with a burner.) A material has fire retardant performance of interest if its LOI value is higher than 21% (vol/vol) which is the concentration of oxygen in the air. Materials possessing higher values of LOI have better the fire retardant properties than materials possessing lower LOI values. The LOI of the present invention articles is desirably at least about 36%.

The invention will now be described with reference to the following description and figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and embodiments.

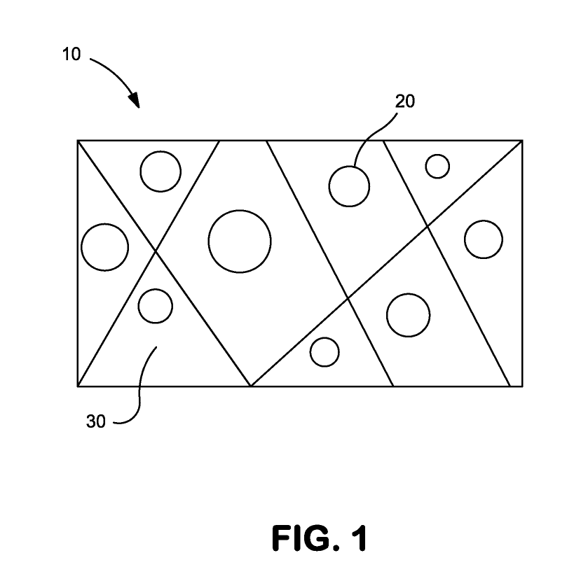

Referring to FIG. 1, the cleaning pad of the present invention includes at least one sheet 10 of a fluoropolymer that contains a cleaning agent 20 in at least a portion of its pores 30. In use, the sheet of fluoropolymer desirably contacts a soiled cooking surface while the cooking surface is still at least warm, up to a temperature of about 550 F.

Fluoropolymers are desirable materials for contacting heated platens of cooking grills because of its high thermal resistance. Suitable fluoropolymers may include, but are not limited to, PTFE, FEP, PFA, and other similar high-temperature fluoropolymer materials. Regardless of the type of fluoropolymer utilized in the cleaning pad, the fluoropolymer should be porous and desirably possess large enough pores to allow at least partial filling of the pores with a cleaning agent. In this regard, the pore structure must also allow for the retention of the cleaning agent inside the pores prior to use. To this end, the sheet of fluoropolymer desirably possesses a bubble point desirably no greater than 1.0 MPA, and more desirably no greater than 0.4 MPa.

Other desirably properties of the sheet include a density of 1.5 g/cc or less, more desirably 1.0 g/cc or less and more desirably 0.5 g/cc or less. The tensile strength is desirably at least 55 MPa in all planar directions. The sheet desirably possesses similar tensile strengths in orthogonal directions. Further, the Gurley air flow test values are desirably less than 10 sec, and more desirably less than 6 sec. The thickness of the sheet is desirably 2 mm or less.

Porous PTFE is a particularly desirable material for this invention, and even more desirably porous PTFE in the form expanded PTFE (ePTFE). The high tensile strength of ePTFE enables it to withstand the relatively high tensile forces encountered during cleaning of a grill surface. Expanded PTFE is described in U.S. Pat. No. 4,187,390 to Gore, the entirety of which is hereby incorporated by reference.

Returning to FIG. 1, the cleaning pads of the present invention may also include a cleaning agent. Non-limiting examples of suitable cleaning agents include water, alcohol, soap, or the like. Additionally, the cleaning pads of the present invention may include an evaporative agent. A non-limiting example of an evaporative agent is acetone. The cleaning agent can be applied to a surface of the pad, in the interior of the pad, inside the pores of the pad material, or any combination thereof. Regardless of how the cleaning agent is applied to the pad, the concentration of the cleaning agent ranges from about 0.007 g/cm² to about 0.025 g/cm².

In use, the evaporative agent and cleaning agent work together within the cleaning pad. In this regard, the evaporative agent, which functions to wet the porous structure of the fluoropolymer, is applied to the fluoropolymer sheet until the sheet is saturated. A cleaning agent is then applied to the sheet to form a cleaning pad. The evaporative agent acts as a carrier to hold the cleaning agent in place within the pores of the cleaning pad. The cleaning pad is then applied to a warm cooking surface, having a temperature of desirably between about 100 F and about 550 F. Upon contacting the cleaning pad with the warm surface, the evaporative agent evaporates because of the heat, and the cleaning agent falls to the cooking surface and interacts with soil on the cooking surface. As the soil and cleaning agent interact, they are drawn into the pores of the cleaning pad because of the absorptive properties of the cleaning pad and the heat of the grill. In this regard (See Examples below) a substantial amount of the soils from the cooking surface can be removed without risking injury (from the heat) to the cleaner, cook, or restaurant worker, because the individual need not come into extended close contact with the hot grill during cleaning.

It is also contemplated, that the cleaning pad could contain cleaning agent and evaporative agent prior to imminent use of the cleaning pad (i.e. during shipping, etc). In this regard, the cleaning pad may contain a release layer loosely attached to one of more surfaces of the cleaning for protecting the pad, its porous openings, and any materials within its porous openings. Non-limiting example of materials suitable for use in a release layer include plastic, paper, polyethylene, and polypropylene. Regardless of the material used in the release film, the film should be sufficiently thin and flexible in order to allow it to be peeled off of the substrate, but it must be strong enough not to break or tear as it is being removed.

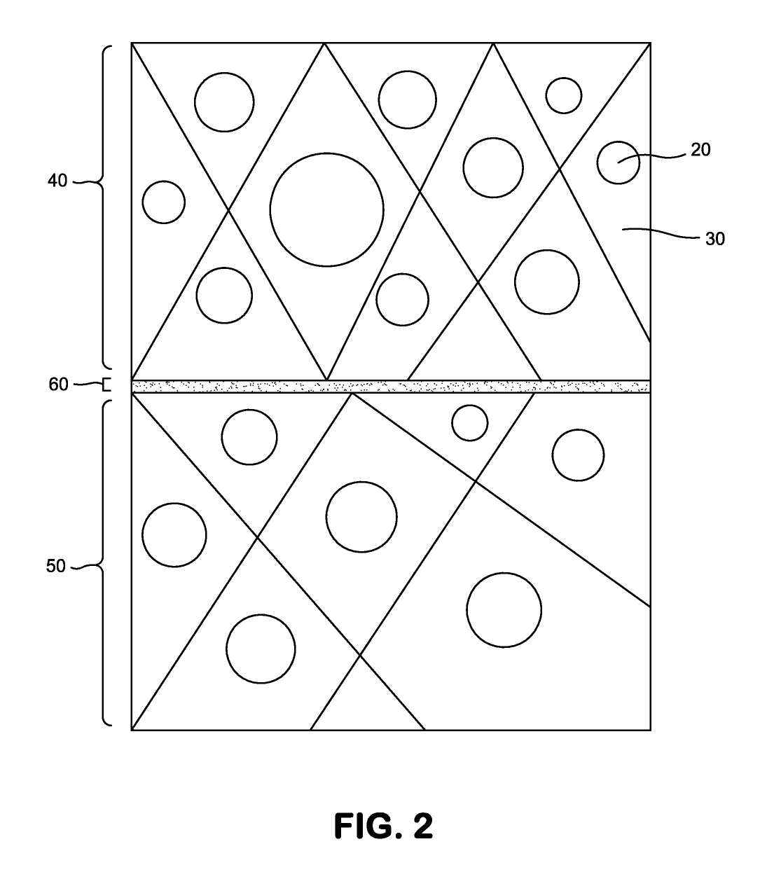

Turning to FIG. 2, the cleaning pad may include multiple layers. In one particular embodiment, three layers are contemplated—two outer layers of porous PTFE (40, 50) and an inner scrim layer 60. The scrim layer (60) is desirably a material with a Limiting Oxygen Index (LOI) value in excess of 22%. LOI indicates the minimum concentration of oxygen in a nitrogen/oxygen mixture required to support combustion of a test sample under specified test conditions in a vertical position, as described in more detail later herein, and can be determined using the test described herein. The composition of this layer can be selected from a group of materials including, but not limited to, nylon, polyester, polyimide, silicones, fiberglass, PTFE, PVDF, etc. The scrim material is preferably porous. This scrim layer may also optionally contain a cleaning agent.

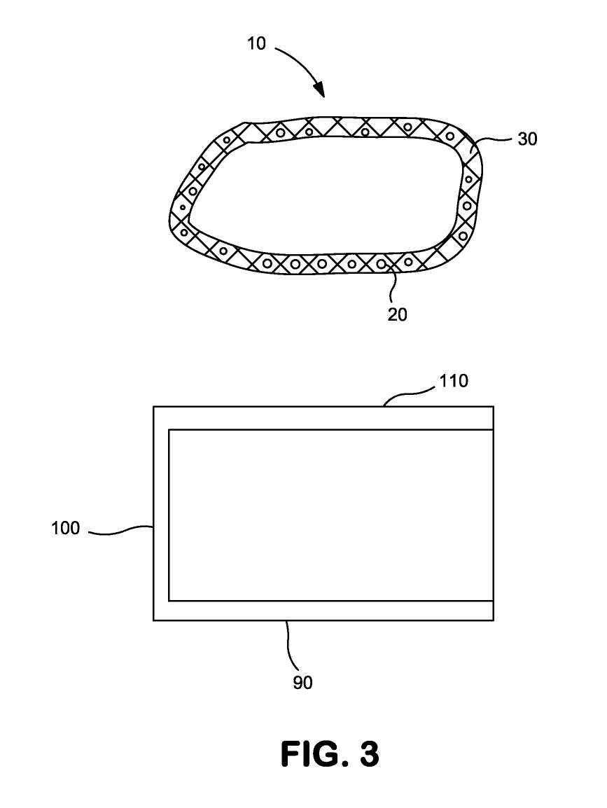

Turning to FIG. 3, in yet another embodiment, a pillow-shaped cleaning pad may be created using at least one porous PTFE sheet 10. FIG. 3 depicts a single sheet of porous PTFE 10 that was folded in half. The three edges (90,100,110) were bonded together to seal them. Bonding can be achieved by any suitable means, including but not limited to heat bonding, adhesive bonding, and the like. The bond preferably withstands temperatures of at least about 288° C. (550° F.). This configuration is designed to inflate upon exposure to cooking temperatures. The inflated pad permits good contact with the upper and lower grill platens, thereby further enhancing cleaning. Alternatively, the pillow-shaped pad can be constructed using two or more sheets of porous PTFE bonded together. The pad optionally contains a cleaning agent.

A variety of methods for utilizing a cleaning pad are also provided herein. These methods are described above and further described below in the Examples. During execution of these methods, various objects may be placed upon the cleaning pad to enhance uptake of the soils into the pores of the pad. These items include, but are not limited to, water, weights, and wet cloths.

The present invention will be further described with respect to the non-limiting examples provided below.

### Test Methods

### Thickness

Membrane thickness was measured by placing the membrane between the two plates of a Kafer FZ1000/30 thickness snap gauge (Käfer Messuhrenfabrik GmbH, Villingen-Schwenningen, Germany). The average of three measurements was used.

Density

Samples die cut to form rectangular sections 2.54 cm by 15.24 cm were measured to determine their mass (using a Mettler-Toledo analytical balance Model AG204) and their thickness (using a Kafer FZ1000/30 snap gauge). Using these data, density was calculated with the following formula:

$$ρ = \frac{m}{w * l * t} ,$$

in which: ρ=density (g/cc); m=mass (g); w=width (cm); l=length (cm); and t=thickness (cm). The average of three measurements was used.

Bubble Point Measurements

The bubble point was measured according to the general teachings of ASTM F31 6-03 using a Capillary Flow Porometer (Model CFP 1500 AEXL from Porous Materials Inc., Ithaca, N.Y.). The sample membrane was placed into the sample chamber and wet with SilWick Silicone Fluid (available from Porous Materials Inc.) having a surface tension of 19.1 dynes/cm. The bottom clamp of the sample chamber had a 2.54 cm diameter, 3.175 mm thick porous metal disc insert (Mott Metallurgical, Farmington, Conn., 40 micron porous metal disk) and the top clamp of the sample chamber had a 3.175 mm diameter hole. Using the Capwin software version 6.62.1 the following parameters were set as specified in the table immediately below. The value presented for bubble point was the average of two measurements.

| Parameter | Set Point | Parameter | Set Point |
|---|---|---|---|
| maxflow (cc/m) | 200000 | mineqtime (sec) | 30 |
| bublflow (cc/m) | 100 | presslew (cts) | 10 |
| F/PT (old bubltime) | 40 | flowslew (cts) | 50 |
| minbppres (PSI) | 0 | eqiter | 3 |
| zerotime (sec) | 1 | aveiter | 20 |
| v2incr (cts) | 10 | maxpdif (PSI) | 0.1 |
| preginc (cts) | 1 | maxfdif (cc/m) | 50 |
| pulse delay (sec) | 2 | sartp (PSI) | 1 |
| maxpre (PSI) | 500 | sartf (cc/m) | 500 |
| pulse width (sec) | 0.2 | | |

Limiting Oxygen Index (LOI)

The limited oxygen indexes of materials used in accordance with the present invention were measured following the general teachings of ASTM D2863, using a limited oxygen index measuring instrument similar to the device described in ASTM D2863 which was manufactured by W.L. Gore and Associates. The specimens were loaded within a fixture to firmly attach films for testing. Specimen dimensions are 2 inches (51 mm) by 5.5 inches (140 mm) long. Oxygen concentrations were adjusted to flaming of specimens reached reference mark of 100 mm. Test was performed 3 times on each material.

Tensile Strength

All specimens were tested according to the general teachings of ASTM D 882-02. A 20 in/min (508 mm/min.) cross-head speed, 2 in (51 mm) gauge length and rectangular specimen of at least 4 inches (102 mm) in length were employed.

Tensile Strength (psi)=Max load (lb)/specimen cross-sectional area (in²), in which Max load=Maximum load specimen generates during testing. The average of three measurements was used.

Gurley Measurements

The Gurley air flow test measures the time in seconds for 100 cm³ of air to flow through a 6.45 cm² sample at 12.4 cm of water pressure. The samples were measured in a Gurley Densometer Model 4340 Automatic Densometer. Articles possessing Gurley values less than about 2 seconds were submitted for Frazier number testing, since this test provides more reliable values for the characterization of highly permeable articles. The average of the three measurements was used.

### Example 1

### Cleaning Fluids

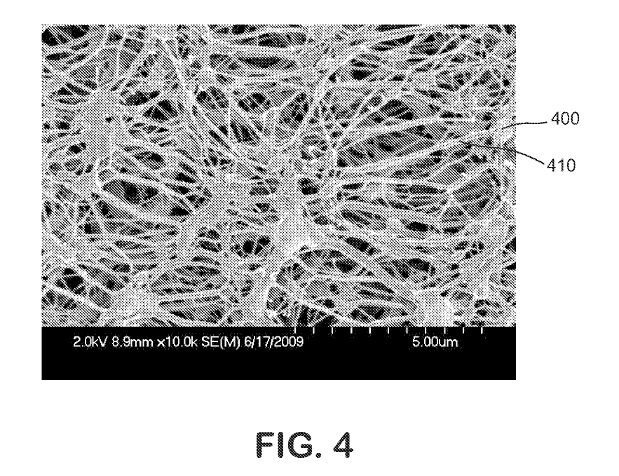

An ePTFE sheet was obtained possessing the following properties: density of 0.50 g/cc, matrix tensile strength of 34 MPa in one direction, matrix tensile strength of 95 MPa in the orthogonal direction, thickness of 0.045 mm, and a bubble point of 0.15 MPa. FIG. 4 is a scanning electron micrograph of the surface of the expanded PTFE material used in this example.

A 100 mm diameter circular piece was cut from the sheet. The circular piece was weighed using a mass scale (Model EP413D, ExplorerPro, OHAUS Corporation, Pinebrook, N.J.). The mass of the piece was 0.20 g.

The circular piece was saturated with acetone and then placed in an approximately 110 mm diameter aluminum pan. Approximately 2 g of a cleaning agent (Kay Chemical Company, Product ID No.: 00301-50, Greensboro, N.C.) was added to the pan.

The piece was heated with a heat gun (Maser Appliance Corporation, Product ID No.: HG-751, Racine, Wis.) to expedite the evaporation of the acetone. This step facilitated the penetration of the cleaning agent into the piece. A cleaning pad resulted.

After drying, the piece was weighed again. The mass was measured to be 0.89 g, which resulted in a 0.009 g/cm² concentration of cleaning agent in the cleaning pad.

Another circular aluminum pan, approximately 110 mm in diameter weighing approximately 1.96 g was obtained. Approximately 2 g of beef lard (Leidy's Lard, Souderton, Pa.) was placed in the circular pan resulting in a weight of 3.96 g. The pan with lard was then placed on a grill set to 350° F. (177° C.). The lard was allowed to liquefy and evenly spread across the pan. The e PTFE cleaning pad was placed flat into the pan. The grill remained heated.

The cleaning pad was removed after lying flat on the heated pan for 5 minutes. The pad had absorbed lard; it was measured to weigh 1.20 g. The pan with the remaining lard and cleaner was also weighed and found to be 3.33 g.

This resulted in a net weight gain of about 1.00 g of lard which was incorporated into the PTFE sheet after the cleaning cycle.

### Example 2

### Double the Concentration of Cleaning Fluids

An ePTFE sheet was obtained possessing the following properties: density of 0.50 g/cc, matrix tensile strength of 34 MPa in one direction, matrix tensile strength of 95 MPa in the orthogonal direction, thickness of 0.045 mm, and a bubble point of 0.15 MPa.

A 100 mm circular piece was cut from the sheet. The circular piece was weighed using a mass scale (Model EP413D, ExplorerPro, OHAUS Corporation, Pinebrook, N.J.). The mass of the piece was 0.20 g.

The circular piece was saturated with acetone and then placed in an approximately 110 mm diameter aluminum pan. Approximately 4 g of a cleaning agent (Kay Chemical Company, Product ID No.: 00301-50, Greensboro, N.C.) was added to the pan

The piece was heated with a heat gun (Maser Appliance Corporation, Product ID No.: HG-751, Racine, Wis.) to expedite the evaporation of the acetone. This step facilitated the penetration of the cleaning agent into the piece. A cleaning pad resulted.

After drying, the piece was weighed again. The mass was measured to be 1.43 g, which resulted in a 0.016 g/cm² concentration of cleaning agent in the cleaning pad.

Another circular aluminum pan, approximately 110 mm in diameter weighing approximately 1.79 g was obtained. Approximately 2 g of beef lard (Leidy's Lard, Souderton, Pa.) was placed in the circular pan resulting in a weight of 3.85 g. The pan with lard was then placed on a grill set to 350° F. (177° C.). The lard was allowed to liquefy and evenly spread across the pan. The e PTFE cleaning pad was placed flat into the pan. The grill remained heated.

The cleaning pad was removed after lying flat on the heated pan for 5 minutes. The pad had absorbed lard; it was measured to weigh 1.80 g. The pan with the remaining lard and cleaner was also weighed and found to be 2.92 g.

This resulted in a net weight gain of about 1.60 g of lard which was incorporated into the PTFE sheet after the cleaning cycle.

### Example 3

An ePTFE sheet was obtained possessing the following properties: density of 0.50 g/cc, matrix tensile strength of 34 MPa in one direction, matrix tensile strength of 95 MPa in the orthogonal direction, thickness of 0.045 mm, and a bubble point of 154 MPa.

A 100 mm circular piece was cut from the sheet. The circular piece was weighed using a mass scale (Model EP413D, ExplorerPro, OHAUS Corporation, Pinebrook, N.J.). The mass of the piece was 0.22 g.

The circular piece was saturated with acetone and then placed in an approximately 110 mm diameter aluminum pan. Approximately 2 g of a cleaning agent (Colgate-Palmolive Inc., Dawn Dishwashing Liquid, Greensboro, N.C.) was added to the pan.

The piece was heated with a heat gun (Maser Appliance Corporation, Product ID No.: HG-751, Racine, Wis.) to expedite the evaporation of the acetone. This step facilitated the penetration of the cleaning agent into the piece. A cleaning pad resulted.

After drying, the piece was weighed again. The mass was measured to be 0.76 g, which resulted in a 0.007 g/cm² concentration of cleaning agent in the cleaning pad.

Another circular aluminum pan, approximately 110 mm in diameter weighing approximately 2.00 g was obtained. Approximately 2 g of beef lard (Leidy's Lard, Souderton, Pa.) was placed in the circular pan resulting in a weight of 4.28 g. The pan with lard was then placed on a grill set to 350° F. (177° C.). The lard was allowed to liquefy and evenly spread across the pan. The e PTFE cleaning pad was placed flat into the pan. The grill remained heated.

The cleaning pad was removed after lying flat on the heated pan for 5 minutes. The pad had absorbed lard; it was measured to weigh 1.50 g. The pan with the remaining lard and cleaner was also weighed and found to be 3.26 g.

This resulted in a net weight gain of about 1.28 g of lard which was incorporated into the PTFE sheet after the cleaning cycle.

### Example 4

An ePTFE sheet was obtained possessing the following properties: density of 0.45 g/cc, matrix tensile strength of 27 MPa in one direction, matrix tensile strength of 125 MPa in the orthogonal direction, thickness of 0.12 mm, and a bubble point of 0.085 MPa.

A 100 mm circular piece was cut from the sheet. The circular piece was weighed using a mass scale (Model EP413D, ExplorerPro, OHAUS Corporation, Pinebrook, N.J.). The mass of the piece was 0.58 g.

The circular piece was saturated with acetone and then placed in an approximately 110 mm diameter aluminum pan. Approximately 4 g of a cleaning agent (Kay Chemical Company, Product ID No.: 00301-50, Greensboro, N.C.) was added to the pan.

The piece was heated with a heat gun (Maser Appliance Corporation, Product ID No.: HG-751, Racine, Wis.) to expedite the evaporation of the acetone. This step facilitated the penetration of the cleaning agent into the piece. A cleaning pad resulted.

After drying, the piece was weighed again. The mass was measured to be 2.52 g, which resulted in a 0.025 g/cm² concentration of cleaning agent in the cleaning pad.

Another circular aluminum pan, approximately 110 mm in diameter weighing approximately 4.39 g was obtained. Approximately 2 g of beef lard (Leidy's Lard, Souderton, Pa.) was placed in the circular pan resulting in a weight of 6.43 g. The pan with lard was then placed on a grill set to 350° F. (177° C.). The lard was allowed to liquefy and evenly spread across the pan. The e PTFE cleaning pad was placed flat into the pan. The grill remained heated.

The cleaning pad was removed after lying flat on the heated pan for 5 minutes. The pad had absorbed lard; it was measured to weigh 2.50 g. The pan with the remaining lard and cleaner was also weighed and found to be 5.71 g.

This resulted in a net weight gain of about 1.92 g of lard which was incorporated into the PTFE sheet after the cleaning cycle.

### Example 5

### Comparative—Dry Sheet

An ePTFE sheet was obtained possessing the following properties: density of 0.50 g/cc, matrix tensile strength of 34 MPa in one direction, matrix tensile strength of 95 MPa in the orthogonal direction, thickness of 0.045 mm, and a bubble point of 0.154 MPa.

A 100 mm circular piece was cut from the sheet. The circular piece was weighed using a mass scale (Model EP413D, ExplorerPro, OHAUS Corporation, Pinebrook, N.J.). The mass of the piece was 0.21 g.

Another circular aluminum pan, approximately 110 mm in diameter weighing approximately 2.3 g was obtained. Approximately 2 g of beef lard (Leidy's Lard, Souderton, Pa.) was placed in the circular pan resulting in a weight of 4.2 g. The pan with lard was then placed on a grill set to 350° F. (177° C.). The lard was allowed to liquefy and evenly spread across the pan. The ePTFE cleaning pad was placed flat into the pan. The grill remained heated.

The cleaning pad was removed after lying flat on the heated pan for 5 minutes. The pad had lard attached to the material but not absorbed within the structure; it was measured to weigh 0.43 g. The pan with the remaining lard and cleaner was also weighed and found to be 3.72 g.

This resulted in a net weight gain of about 0.22 g of lard which was incorporated onto the ePTFE sheet after the cleaning cycle.

### Example 6

### Comparative—Surfactant Only

An ePTFE sheet was obtained possessing the following properties: density of 0.50 g/cc, matrix tensile strength of 34 MPa in one direction, matrix tensile strength of 95 MPa in the orthogonal direction, thickness of 0.045 mm, and a bubble point of 0.154 MPa.

A 100 mm circular piece was cut from the sheet. The circular piece was weighed using a mass scale (Model EP413D, ExplorerPro, OHAUS Corporation, Pinebrook, N.J.). The mass of the piece was 0.21 g.

Another circular aluminum pan, approximately 110 mm in diameter weighing approximately 1.96 g was obtained. Approximately 2 g of beef lard (Leidy's Lard, Souderton, Pa.) was placed in the circular pan resulting in a weight of 4.41 g. The pan with lard was then placed on a grill set to 350° F. (177° C.). The lard was allowed to liquefy and evenly spread across the pan. The e PTFE cleaning pad was placed flat into the pan. The grill remained heated.

The ePTFE circular article was then saturated with acetone resulting in a weight of 0.88 g and immediately placed in the pan with lard on the grill. The ePTFE article was then removed after 5 minutes. The ePTFE article was then reweighed and measured to be 0.88 g (acetone evaporated from heat). The circular pan with the remaining lard and cleaner was also weighed and found to be 3.72 g.

This resulted in a net weight gain of about 0.67 g of lard which was incorporated into the PTFE sheet after the cleaning cycle

### Example 7

### Cleaning Pillow Used to Clean Both Upper and Lower Platens Simultaneously

A cleaning pillow was constructed from two layers of ePTFE membrane in the following manner. The ePTFE membrane had the following properties: thickness of about 0.045 mm, density of 0.501 g/cc (the thickness and density correlate to a mass per unit area of 22.5 g/m²), Gurley number of about 7 to 10 seconds, bubble point of about 0.14-0.17 MPa (about 22.3-25 psi), and tensile strengths in orthogonal directions of 34 MPa and 95 MPa. Two sheets of the ePTFE membrane about 30.5 cm long×55.9 cm wide (about 12 inch×22 inch) were laid flat, one directly on top of the other. A 0.0025 cm (0.001 inch) thick by 2.5 cm (1 inch) wide strip of PFA tape (Part No. 100, E. I. du Pont de Nemours, Inc., Wilmington, Del.) was placed between the two membranes around their perimeters. The edges of the ePTFE were then sealed to the PFA using a Vertrod heat sealing machine (Model number 12EP/P-1/2WC-CAN-HOV-SP, Vertrod, Inc., San Rafeal, Calif.) was used to apply heat and pressure to the folded edge. The machine settings were as follows:

| Mode | Tempulse |
|---|---|
| Upper temperature set point | 705° F. |
| Lower temperature set point | 200° F. |
| Powerstat | 70% |
| Proportioning timer | 35 seconds |
| Pressure (gauge) | 100 psi |

With the heat sealer set to these conditions, the folded edge of ePTFE with PFA strip was inserted between the machine jaws and the bonding cycle started. Eight bonding cycles were used to bond the entire edge.

Once sealed, the resultant pillow was saturated with acetone, then placed in a pan and submerged in approximately 20 g of a cleaning agent (part number 00301-50, Kay Chemical Company, Greensboro, N.C.).

The pillow was heated with a heat gun (part number HG-751, Maser Appliance Corporation, Racine, Wis.) to expedite the evaporation of the acetone. This step also facilitated the penetration of the cleaning agent into the pillow. A translucent, pink-tinted cleaning pillow resulted.

A second pillow was prepared in exactly the same manner. A circular section of 100 cm² area of this pillow was weighed. The quotients of the mass and area of the sections of four samples of the imbibed ePTFE cleaning pillow yielded 55.3, 54.1, 52.5 and 54.7 g/m², which corresponded to about 33 g/m² of cleaner present in the pillow.

A three-grill Garland clam shell grill (Garland Xpress Grill Model XE36, NewPort Richey, Fla.) was obtained. The grill was set up in accordance with the manufacturer's instructions.

About 50 hamburgers and sausages were fully cooked on the clam shell grill at a temperature of about 350° F. for the bottom platen and 425° F. for the top platen for approximately 1 minute each, until the grill upper and lower surfaces were covered with tightly adhered fat, proteins and soils.

To begin cleaning, the grill was turned off and the cleaning begun with the grill still hot. The bottom platen was scraped and wiped with a squeegee. The cleaning pillow was positioned on top of the bottom platen surface. The upper platen was lowered with the grill still in “off” mode. Within 5 seconds of lowering the top platen, the pillow inflated, partially wrapping around the edges of the upper platen, making good contact with both upper and lower cooking surfaces. About 10 seconds later the bag started to deflate. After 5 minutes, the upper platen was raised. Most of the soil was attached to the cleaning pad and removed along with the pillow. The pillow was uniformly brown in color with a few darker spots which indicated good uniform contact on both top and bottom heating surfaces.

### Example 8

### Cleaning Pad with Scrim

A cleaning pad was constructed from two layers of ePTFE membrane in the following manner.

An ePTFE membrane possessing the following properties was obtained: thickness of 0.02 mm, density of 0.4 g/cc, Gurley number within the range of about 2.5-4.5 seconds, bubble point of about 0.12 MPa, and tensile strengths in orthogonal directions of ADD MPa and ADD MPa. FIG. 4 shows a scanning electron micrograph of the surface of the ePTFE membrane. The structure of the material is seen to be comprised of nodes 400 interconnected by fibrils 410.

The membrane was cut to provide two circular pieces about 100 cm² in area. A sheet of polyester (Part Number 165, HDK Industries, Rogersville, Tenn.) was also obtained and cut to the same size and shape.

Each ePTFE layer was separately imbibed with acetone, followed by being imbibed with a cleaning agent (part number 00301-50, Kay Chemical Company, Greensboro, N.C.). The layers were heated with a heat gun (part number HG-751, Maser Appliance Corporation, Racine, Wis.) to expedite the evaporation of the acetone. This step facilitated the penetration of the cleaning agent into the ePTFE layers. The nylon was also imbibed with the cleaning agent.

The nylon sheet was placed between the 2 layers of ePTFE, thereby creating a 3 layer stack. A translucent, pink-tinted cleaning pad resulted.

A three-grill Garland clam shell grill (Garland Xpress Grill Model XE36, NewPort Richey, Fla.) was obtained. The grill was set up in accordance with the manufacturer's instructions.

The grill was then soiled by cooking 50 hamburgers on top of the grill surface. After cooking, the grill surface contained fats, oil and residue from the cooked hamburger patties that charred to the grill surface which was at a temperature of 177° C. (350° F.).

To begin cleaning, the grill was turned off and the cleaning initiated with the grill still hot. The bottom platen was scraped and wiped with a squeegee. The top platen, at a temperature of 218° C. (425° F.), was only wiped with a squeegee and a wet cotton cloth and sprayed with water from a spray bottle. Importantly, the grill surfaces were not scrubbed with a mesh pad, a standard current cleaning step.

Next, the cleaning pad was draped across the bottom platen surface. The upper platen was lowered with the grill still in “off” mode. After about 5 minutes, the top platen was raised. The cleaning pad was removed from the grill. It was soiled with fats and greases from the grill surfaces. Water was spread across the bottom grill surface in order to remove excess cleaning fluid. The grill was seen to be as clean as it was prior to cooking.

While the invention has been disclosed herein in connection with certain embodiments and detailed descriptions, it will be clear to one skilled in the art that modifications or variations of such detail can be made without deviating from the spirit of the invention, and such modifications or variations are considered to be within the scope of the claims herein.

The invention claimed is:

1. A cleaning pad comprising:
a) at least one porous PTFE sheet comprising pores, said at least one porous PTFE sheet comprising a density of up to about 1.5 g/cc;
b) a cleaning agent, wherein at least a portion of pores comprises said cleaning agent; and
c) an evaporative agent, wherein at least a portion of said pores comprises said evaporative agent.

2. The cleaning pad of claim 1, wherein the cleaning agent is the cleaning pad of claim 1, wherein the cleaning agent is water, alcohol, soap, the like, or combinations thereof.

3. The cleaning pad of claim 1, wherein the evaporative agent is acetone.

4. The cleaning pad of claim 1, wherein the evaporative agent facilitates the uptake of the cleaning agent into the pores of said at least one porous PTFE sheet.

5. The cleaning pad claim 1, wherein the cleaning agent adapted to facilitate the uptake of soil into said pores of said at least one porous PTFE sheet.

6. The cleaning pad of claim 1, wherein the at least one porous PTFE sheet has a bubble point of 0.15 MPA or less.

7. The cleaning pad of claim 6, wherein the at least one porous PTFE sheet has a bubble point of 0.10 MPA or less.

8. The cleaning pad of claim 1, wherein the at least one porous PTFE sheet comprises a density of up to about 1.0 g/cc.

9. The cleaning pad of claim 8, wherein the at least one porous PTFE sheet comprises a density of up to about 0.5 g/cc.

10. A cleaning pad comprising:
a) at least one porous PTFE sheet comprising pores, said at least one porous PTFE sheet comprising a density of up to about 1.5 g/cc;
b) a cleaning agent, wherein at least a portion of pores comprises said cleaning agent; and
c) an evaporative agent, wherein at least a portion of said pores comprises said evaporative agent.
d) a release layer adjacent said at least one porous PTFE sheet.

11. A cleaning pad comprising:
a) a pillow comprising at least one porous PTFE sheet comprising pores, said at least one porous PTFE sheet comprising a density of up to about 1.5 g/cc;
b) a cleaning agent, wherein at least a portion of pores comprises said cleaning agent; and
c) an evaporative agent, wherein at least a portion of said pores comprises said evaporative agent.

12. A method of cleaning a soiled cooking surface, the method comprising:
a) providing at least one porous PTFE sheet comprising pores
b) applying an evaporative agent to said at least one porous PTFE sheet comprising pores
c) applying a cleaning agent to said at least one porous PTFE sheet comprising pores.
d) placing said at least on porous PTFE sheet comprising pores onto a soiled cooking surface.
e) evaporating the evaporative agent.
f) distributing the cleaning agent onto the soiled cooking surface.
g) drawing the soil from the cooking surface onto the PTFE sheet.

13. The method of claim 12, wherein the method is performed while the cooking surface has a temperature from about 100 F to about 550 F.

14. A method of cleaning a soiled cooking surface, the method comprising:
a) providing a cleaning pad comprising at least one porous PTFE sheet comprising pores; a cleaning agent, and an evaporative agent.
b) placing said cleaning pad onto a soiled cooking surface.
c) evaporating the evaporative agent.
d) distributing the cleaning agent onto the soiled cooking surface.
e) drawing the soil from the cooking surface onto the cleaning pad.

15. The method of claim 14, wherein the method is performed while the cooking surface has a temperature from about 100 F to about 550 F.

16. The method of claim 14 comprising the additional step of placing a wet cloth on top of the cleaning pad.

17. The method of claim 14 comprising the additional step of adding weight to the top surface of the cleaning pad.

18. The method of claim 14 comprising the additional step of adding water to the top of the cleaning pad.

19. The method of claim 14, wherein the soiled cooking surface is visibly free of soil upon completion of the method.

20. A cleaning pad comprising:
a) two porous PTFE sheets comprising pores, said sheets each comprising a density of up to about 1.5 g/cc;
b) a cleaning agent, wherein at least a portion of pores comprises said cleaning agent; and
c) an evaporative agent, wherein at least a portion of said pores comprises said evaporative agent.
d) a scrim layer sandwiched between said two porous PTFE sheets.

21. The cleaning pad of claim 20, wherein said scrim layer comprises nylon, polyester, polyimide, silicones, fiberglass, PTFE, PVDF, the like, or combinations thereof.

22. The cleaning pad of claim 20, wherein said scrim layer comprises a cleaning agent.
